(19) United States
(12) Patent Application Publication
(10) Pub. No.: US 2010/0075282 A1
(43) Pub. Date: Mar. 25, 2010

(54) Omnidirectional word construction pedagogical tool and learning game

(76) Inventor: Gregory J. Yu, Hillsborough, CA (US)

Correspondence Address: Gregory J. Yu, #714, 1325 Howard Ave., Burlingame, CA, 94010, US

(21) Appl. No.: 12/462,073

(22) Filed: Jul. 28, 2009

Related U.S. Application Data
(60) Provisional application No. 61/137,259, filed on Jul. 28, 2008.

(51) Int. Cl. G09B 1/00

(52) U.S. Cl. 434/172

(57) ABSTRACT

A method of learning and teaching words by the insertion and addition of letters to a pre-existing chain or minimal pair of letters of a language within a grid or array of preprinted spaces to allow the learner to visualize the placement of letter to build a word for discovery. Bother the learner and instructor can consult a dictionary database to test and identify all possible valid words that contain a given chain or pair of letters.

### CROSS-REFERENCES TO RELATED APPLICATIONS

This application claims the benefit under 35 U.S.C. §119(e), to U.S. Provisional Application No. 61/137,259 filed Jul. 28, 2008, entitled “OMNIDIRECTIONAL WORD CONSTRUCTION PEDAGOGICAL TOOL AND LEARNING GAME” which is incorporated by reference into this application as if fully set forth herein.

### FEDERALLY SPONSORED RESEARCH

Not Applicable

### SEQUENCE LISTING OR PROGRAM

Not Applicable

### 37 C.F.R. 1.71 AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office records, but otherwise reserves all copyright rights whatsoever.

### BACKGROUND

1. Field of Invention

The present invention generally relates to diagnostic learning, testing and assessment. More specifically, the present invention relates generally to diagnostic and rehabilitative learning, learning, testing and assessment regarding spelling and vocabulary.

2. Description of Prior Art

Spelling, vocabulary, grammar and stroke composition are fundamental skill sets for a person learning or re-learning her native language (native language learners or “NLL”) and those engaged in acquiring a second language (second-language learners (“SLL”). A significant segment of NLLs are those persons requiring speech rehabilitation as a result of communication disorders, such as those afflicted with aphasia.

Instruction, rehabilitation, learning, and assessment should be interconnected and iterative processes. A student advances in their learning and expertise in spelling and learning through attempting new word formation through speech, reading, and writing in the language. More importantly, in many instructional, rehabilitative, tutorial or training processes in a variety of disciplines, prompt and accurate feedback is essential. Even the delivery and process of feedback to the learner, whether in a positive or negative tone and setting, is often critical to effective learning where children are learning to mature and interact among adults and among their peers.

Most commonly, successful attempts at assessing, teaching and learning spelling begin with mastery of the entire alphabet in a given language. Once the alphabet is mastered, the learner can begin proper word construction. A mastery of spelling is deeply correlated with the phonological awareness. This is the precise skill used for achievement in spelling bees and the weekly spelling list for children.

For children being tested publicly and in a group setting, words are announced in serial fashion in spelling bees. The moderator announces a word to each competitor, and the competitor must orally spell the word under intense and frequently unwanted attention if an error is made. If it is misspelled, that competing student is eliminated from the spelling bee, unless only two finalists remain (under conventional rules). A spelling bee is appealing for spectators, but for children forced to compete and getting eliminated early or by stumbling on a word, fear and stigma are attached to failure. This can impede the entire experience process or learning to spell, make mistakes, and receiving a reward for success, rather than a penalty for failure. Indeed, a growing number of students face a variety of learning disabilities. Public embarrassment from failing in a spelling bee is not likely to be worthwhile for any learning or maturation process, particularly for those with learning disabilities or exceptional needs. Similarly, those with communicative disorders suffer from the fear of failure or embarrassment when trying to re-acquire spelling and verbal skills as an adult.

Assessment and teaching of spelling and vocabulary are two different processes altogether. For assessment, there are a variety of both formal and informal assessment tools. In the formal genre, teachers use achievement and diagnostic tests, as well as criterion-referenced tests. Informal methods include dictated spelling tests, informal spelling inventory, curriculum-based measurement, spelling error analysis, Cloze procedure, probes, modality testing, and others. For teaching, the array of tools may include rule-based instruction, multisensory approach, test-study-test technique, fixed and flow word lists, imitation methods, and basal spelling program. Learning a native language or SLL is generally achieved through the dissection of words into their elements of letters. This involves an exhaustive analysis of phonics using letters and combinations of letters.

In the educational context, a challenge remains on the need to connect spelling accuracy with reading and writing. It is believed that approximately 90% of elementary school teachers in the United States use weekly spelling lists, but achievement are based upon memorization and visualization alone. The result is only nominal incremental gains in writing skill and ability for students.

Standardized and collective teaching means that an entire group or class of students is required to learn the same material. It is believed that about 75% of all teachers assign a single list to the entire class of students to learn. This technique may dispense with the value of individualized learning and development for students who vary in their skill, interest and discipline. Furthermore, students normally do not contribute to the spelling list as the instructor or district will presume which words are suitable for learning. Curiosity and imagination must yield to memorization.

For educational and tutorial settings, a variety of learning games, tools and manipulatives may be utilized to build a student's learning of vocabulary and spelling. Certain games and group exercises can test and enhance a learner's vocabulary and spelling skills. These games may employ word chains, word searches, word extending, word unscrambling, word transforming, and word extracting. Some games construct multidirectional word bridges across a board with the placement of one or more letters in a direction to form a new word sharing a letter of a previously placed word. A popular game is Scrabble.®, which may be considered both a strategy and a challenge for players, the number of letter tiles is reduced and eventually exhausted by successive rounds of play during this game. With another game, Upwords.®, letter tiles to add to or overlay existing letters of a previously played word. Learning is quite frequently a natural consequence of such word games because there is player experimentation, curiosity and imagination without discipline.

Many of the spelling and word games employ a random selection and a targeted or intentional placement of letters together to form words or roots. These may be effective only to the extent that the instructor or computer can deliver immediate or prompt feedback to the learner. Absent prompt and correct feedback, the learner may actually begin to form habits and patterns in spelling that must be corrected at a later time.

In the rehabilitative and recovery settings, games and exercises are also available to promote gains in cognitive and speech skills. Some of these games and exercises involve a therapist, while others may be self-exercised.

U.S. Pat. No. 4,768,959 to Sprague, et al. (1988) is an apparatus and method for increasing language skills by associating sounds and pictures with phonomats with a teacher-directed approach to instruct students of new words.

U.S. Pat. No. 6,676,412 to Masterson, et al. (2003) teaches an assessment tool to search for patterns in errors after a student has attempted to spell a series of words, but does not require the student to initiate and discover patterns and phonemes with self-intervention.

U.S. Pat. No. 7,479,011 to Wang, et al. (2009) claims a system to audibly project a word to a student who is assessed and scored for attempts and successes in spelling the word correctly. This art does not require a student to identify new words for discovery and self-assessment.

U.S. Patent Application No. US 2006/0216678 claims methodologies to visually, textually and aurally stimulate exercises driven by a computing device and does not utilize collaborative self-discovery.

### SUMMARY OF THE INVENTION

Aspects of the present invention disclose an instructional method to assess, learn, develop and reacquire spelling and vocabulary skills. NLLs and SLLs and any others seeking to gain, improve, master or reacquire these to use a method of forming words with predetermined letter settings, formations and combinations. Two or more letters of a language are placed adjacent to each other in a linear array, with at least one blank spaces on each sides add to the letter chain. The combined pair of letters may be two consonants, two vowels or one consonant paired with one vowel, in either order.

In a solo training or learning session, the active learner may add a single letter to the front or back of the array to test and explore what letters can lead to the creation of a new word to be learned. By testing and forming new chains that are verified by an instructor, teacher, therapist, computer, or other learner with access to a dictionary of the language, the active learner can build and rebuild spelling, pronunciation, and vocabulary skills. As the learner uses any given letter, minimal pairs are revealed. Minimal pairs are pairs of words wherein the words have pronunciation that differs at only one segment. The invention in part offers a methodical, logical, and alphabetical means to enhance language skills.

In a group or combined learning session, two or more learners can work together to form words. A teacher, moderator or therapist can engage the learners in a rules-based word exercise or game with two or more players, which may, in varying embodiments, include either persons or a programmed computer.

The object of the exercise or game can be a variety of options. One object would be to create valid words by the addition of a single letter to either the front or back of the pre-set paired letters. Each learner would be faced with the identical or shared set of letters on which to build words. These newly created chains would be subject to verification by a reliable human or computer source. An alternative object would allow learners to take turns with each other to add single letters to build longer words without actually creating a full valid word. The learner gains points for each letter added, but if a new word is formed, or a new chain is created that is not valid within the language of learning, points are lost.

Learning is expanded then the pre-set number of letters becomes a full syllable, phoneme, or root word. Learners are then prompted to build on their knowledge and learning of the language as they must learn and recognize longer letter chains.

A suitable platform for the exercise and game may include a paper or erasable surface containing preprinted space grids. Or, a physical piece such as a card, block or tile could have the pre-printed pair of letters available for use as each learner adds a piece in turn, each containing a unique letter to add to the word chain. An alternative and additional embodiment platform for the invention would use a computer with an electronic display screen appearing on a PC, a laptop computer, or imbedded in a handheld electronic device.

Following each exercise or round, the learners, teachers, and instructors can discuss the results of the words built, whether correctly or invalidly, by any given learner. Each word may then be followed by assessing the learner's understanding of the meaning, and use of the word in a sentence, both orally and in written format. Test of the word can be done orally or in writing by the learner. This process will encourage the learner to ask about the possibilities of variations of letters appended to the front or back of each pre-set letter chain. The objective would be to spur the curiosity, recall and imagination of learners from their past communications, learning, activities, and exposure to media and other persons.

### DRAWINGS

The present invention will be better understood by consideration of the detailed description that follows. The description will make references to these figures and their elements:

FIG. 1A is a view of an embodiment workbook for word construction and letter insertion.

FIG. 1B is a view of an embodiment workbook referred to in FIG. 1B reflecting exemplar handwritten entries.

FIG. 3 is a view of an embodiment worksheet for word construction and letter insertion, with an added section to show how multiple persons may build words together and maintain score in a game or learning exercise format.

FIG. 4 is an embodiment guide used to evaluate the skill and performance of a group of persons for evaluation of word construction skills with letters.

FIG. 5 is a view of a reproducible student work sheet with a sample minimal pair of letters for word construction and letter insertion.

FIG. 6 is a computer screen showing the electronic use of clicking and dragging letter images to be placed adjacent to minimal pair for word construction.

FIG. 7 is a computer screen presentation of possible valid words programmatically retrieved from a dictionary database that are associated with a certain minimal pair of letters.

FIG. 8 is a flat playing surface showing a grid of bordered spaces for placing letter cards, which spaces are designated with numeric and algebraic notation.

### REFERENCE NUMERALS IN DRAWINGS

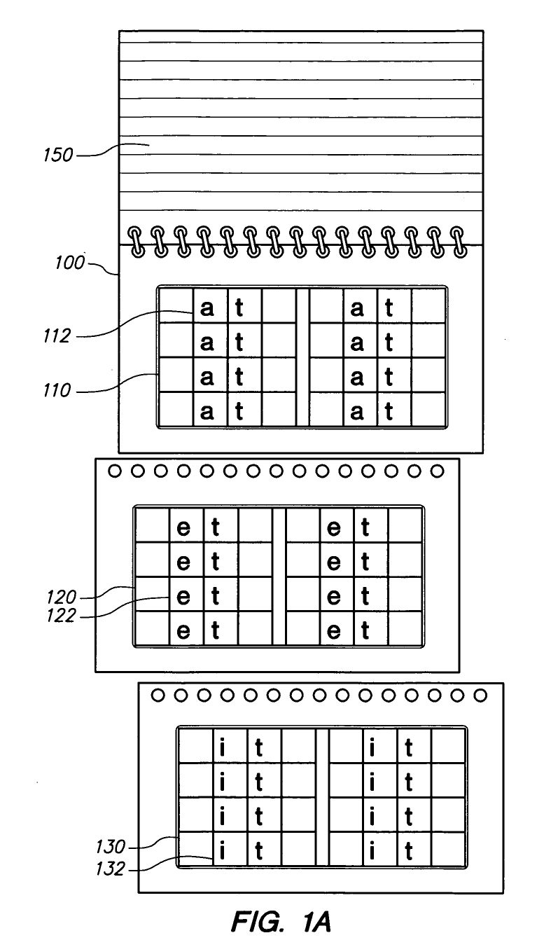

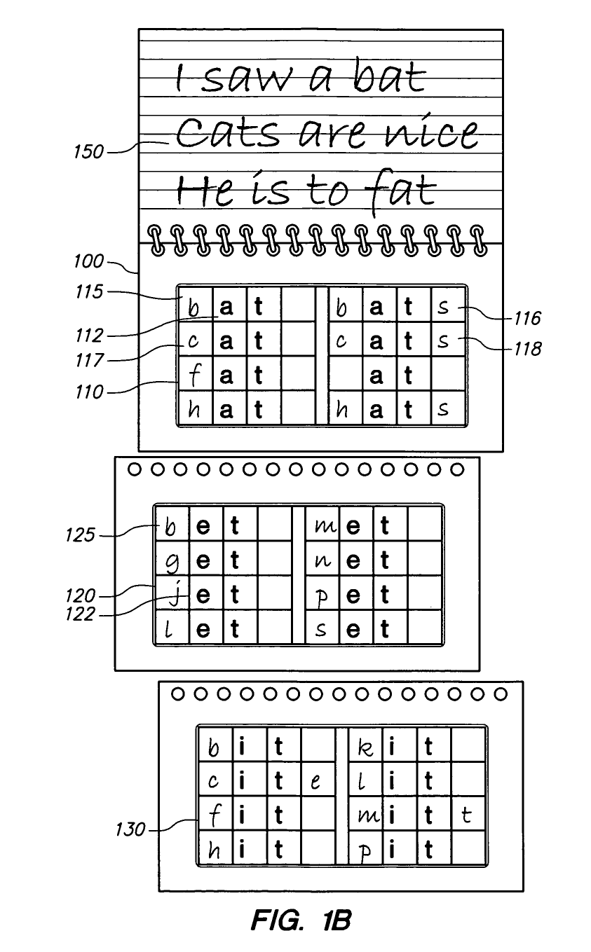

Workbook 100, FIG. 1A, provides a bound set of cards or pages in a variety of dimensions for use by a student, patient, or language learner. This spelling teaching tool shows on the facing page with matrix 110 of boxes to show example embodiment preprinted letter combinations 112 featuring, for example, ‘at’ eight times in two columns. In each row of matrix 110 are adjacent blank letter spaces for letters to be written in. Letters can be in lower case or in all capital letters. The opposite page 150 shows a lined region for writing to be inserted by hand.

Matrices 120 and 130 in FIG. 1A show different example embodiment letter combinations using exemplar vowels of ‘e’ and ‘I’ in front of the same consonant T to form the combinations of ‘et’ and ‘it’. Multiple pages appear in work book 100 for any number of letter combinations with any number of blank letter spaces to either side of the

Opposite facing page 150 may also present drawings, figures, clues to aid the user of the workbook 100 to learn and identify words containing the letter combination. There may also be spelling and vocabulary content for use by the learner.

FIG. 1B depicts workbook 100 with various example content and letters as would be inserted by a learner. Letter combination 112 showing ‘at’ was used by the learner in the first row to great the word tat' by inserting a letter ‘b’ in block 115 to create the word. In the second column, the learner repeated the word, but added the letter ‘s’ in block 116 to create the plural form of bat, or ‘bats’. Similarly, the learner formed another word by adding a letter ‘c’ in block 117 to form ‘cat’, and still another word by adding a letter ‘s’ in block 118 to form ‘cats’. Workbook sheet 120 generally depicts a different example letter combination 122 of ‘et’ and the learner created another word 125 ‘bet’ by added a letter ‘b’ in front of combination ‘et’. Workbook sheet 130 illustrates yet another letter combination for the learner to create words ending in the letter combination ‘it’.

Opposite facing page 150 is lined and ruled for the learner to write words. The example learner wrote three sentences using the first three words appearing on the facing page—‘bat’, ‘cat’, and ‘fat’. These sentences are subject to review and correction by the instructor, teacher or parent of the learner.

Opposite facing page 150 may be used for other learning exercises to train the learner in spelling, vocabulary and comprehension. As one embodiment, the learner may be asked to practice penmanship by writing words multiple times to practice her lettering and script. The learner may also use a dictionary to look up and write a definition of a newly formed word on the facing page that was unknown to the learner prior to the exercise. There is a myriad of options for the instructor, teacher or parent to use to aid the learning of new words. It is important that in the case of an NLL or an SLL subject that the learning be individualized and customized wherever necessary or possible to address needs and goals of the learner.

In the example of the English language, there are 5 vowels and 21 consonants, with ‘y’ used as a vowel as well. A computerized database of words can be used to search for all possible words containing, beginning or ending with a particular letter combination. FIG. 2 shows the five available letter combinations with the five vowels—a, e, I, o, and u—ending with the consonant T. Software can design and generate preprinted matrices for affixing in workbook 100. For educating children, the parent, teacher or curriculum director can establish guidelines or standards for which letter combinations to learn and practice on.

All such combinations may be catalogued in a master database in order to allow the programmatic creation of matrices for use by the adult guiding and teaching the child learner.

FIG. 2 shows five different matrices of letter combinations in the first column as shown in matrices 200, 220, 240, 260, and 280 for the five vowels preceding the consonant T. Letter combination 205 and 215 shown as ‘at’ appears in duplicate in the left and right columns. Having numerous blank rows with the letter combination allows the learner to explore multiple words with the combination, even by trial and error.

These matrices can be preprinted in a bound workbook 100, or can be affixed as labels off letter-sized backing sheets in duplicate.

Workbook 100 may allow for perforated sheets or cards to allow the instructor to collect and assess both the individual learner and the group as a whole. Upon evaluation and grading, the instructor can return these to the learner for her review as well as by the parents of a student learner. The present invention may also be used in a group or individualized setting for testing purposes wherein the learner detaches the card or cards for submission to the instructor for grading and assessment.

For formal instruction of NLLs and SLLs, a teacher or instructor will have a guide to train and teach the learner for assessment, learning, and enhancement. This guide will provide formal assessment and feedback to both the teacher and the learner about the results and impact of the exercise or game, as the case may be.

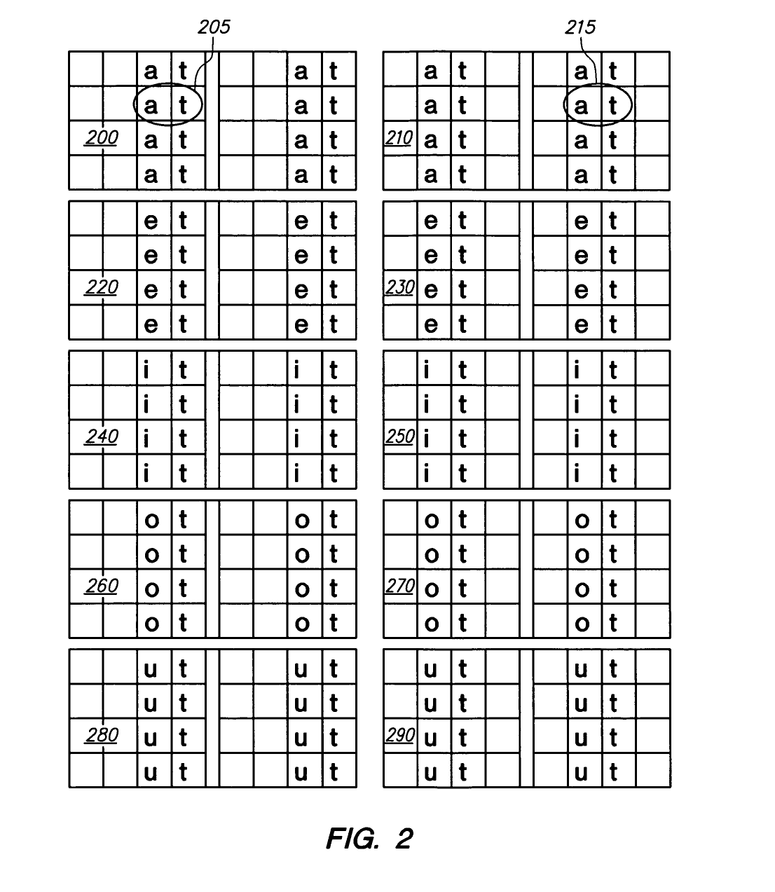

FIG. 3 is a printed sheet 305 of letter combinations in matrix 300. Instruction can be delivered to NLLs and SLLs in this different format to allow greater coverage and space than smaller cards bound in workbook 100. The rows in matrix 300 are numbered 1 through 12, each with the letter combination of ‘ab’. Matrix 300 may be used by one learner to form and develop words. Sheet 305 is a means of playing a game to allow multiple learners to form words and learn spelling and vocabulary together and concurrently. Example rules 330 outline an embodiment reflecting certain rules that may be explained by the adult instructor of a group of learners. These rules allow for turn-based play to allow learners to add letters to the preprinted letter combinations. It may be practicable for each player in succession takes turns entering a letter using their own uniquely colored pen or marker. If a word is created, points may be awarded to the learner.

Another embodiment of rules can allow for more advanced learners to add single letters that continue but do not complete the construction of a valid word of a chosen language. Additional characters to be played only to the immediate right side or left side of the array with no blank spaces between characters previously played and new characters. The active learner who places a single character that either creates a valid word or creates a new sequence that does not exist in the language may be challenged by another learner or a computer. If the active learner wins the challenge, additional points are given for letters played. If the active learner loses the challenge, she may be penalized by losing points, or additional points are awarded to the challenger.

To aid in the instruction and the play, an adult instructor or teacher can also be a player in this game and exercise. Challenges may be resolved by consulting an electronic dictionary with a search function for letter combinations. A variety of rules in this embodiment may be established. These may include without limitation that valid words are at least two or more characters, letters or strokes. Also, the game and exercise may allow or disallow the use and creation of foreign words, proper nouns, abbreviations, or words spelled with apostrophes or hyphens.

An interactive electronic version of the invention as workbook 100 in FIG. 1A can be designed and operable on a laptop, PC, handheld device. This would allow for automated, user-triggered and user-chosen exercises with various letter combinations. An electronic log can maintain the learner's work, progress and exercises. Each set of exercises can be stored and accessed for both learning and assessment by the instructor. An imbedded, downloadable or online dictionary may be used both for the exercises in workbook 100 or for sheet 305, FIG. 3, to aid in building vocabulary, or resolve challenges in a game setting, as the case may be. Further, the invention can be applied in an online interactive session to allow learning, testing and assessment to be achieved remotely. The content shown in FIGS. 1A, 2, 3, and 4 may be presented in an embodiment that leverages the ease and advantages of a computer and word processor. Still, the versions in a manual setting enhance writing and penmanship skills of learners, especially children at the elementary school level who need to master basic writing and spelling skills without the aid of a computer, word processor or automated spell checker.

The preferred embodiment of the invention in a group educational setting allows the instructor to oversee and customize learning by all the learners. FIG. 3 is an embodiment example record that organizes and catalogues the study of vowels and letter combinations. Vowel 410 is the letter ‘A’ being studied. A total of 11 word segments beginning with ‘a’ are shown in position 430. Row 432 presents each of the 11 letter combinations beginning with ‘a’ to be studied by the group of learners. Segment 434 ‘AB’ is studied by the group. Column 441 shows a list of 16 students in this learning group unit. The students are divided into four groups by group color 442. Within teams of four, the student learners use workbook 100 or sheet 305 to learn words with the letter combination. The instructor may set a variety of group rules and protocol to facilitate group learning of the segment. Column 443 is the tally of words discovered by the group color. This encourages shared learning among a group of students of varying abilities. On an individual basis, column 444 is the number of words successfully and properly used in a sentence. Left side 444a of column 444 shows the number of different words containing the segment used in a spoken sentence and right side 444b presents the number of words used in a written sentence. Column 445 is the number of words that are mastered by the learner under guidelines and criteria set by the instructor, teacher, parent or by standardized curriculum.

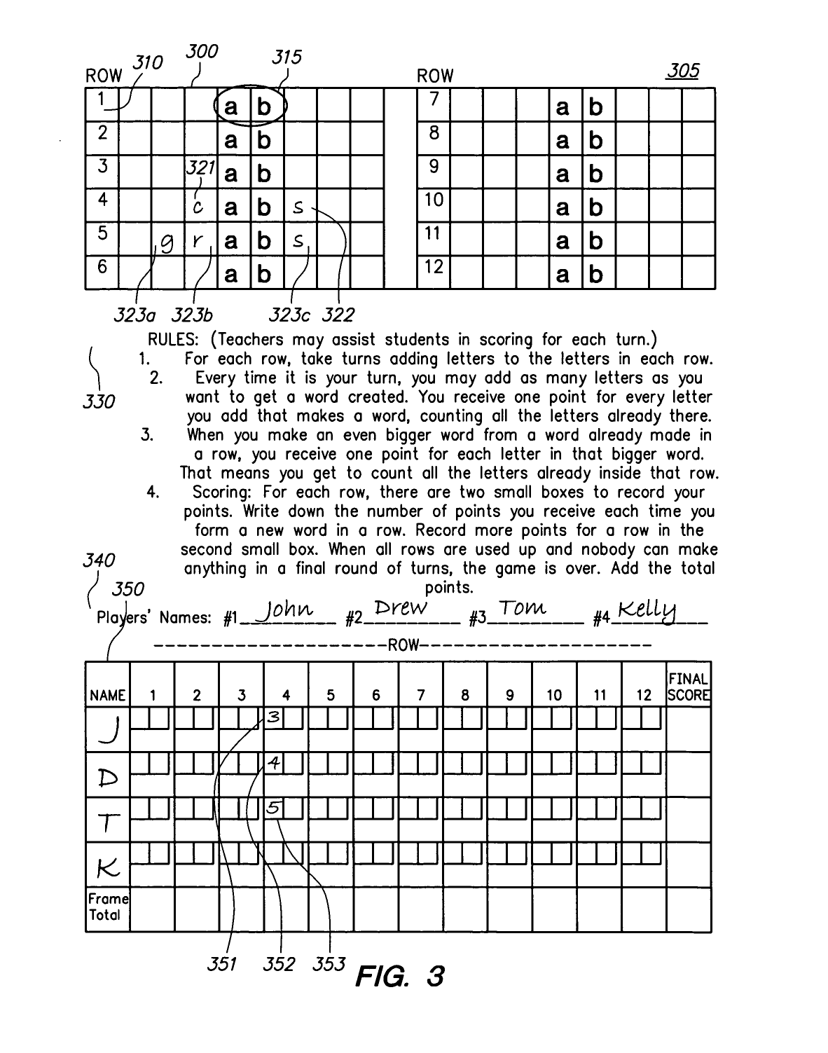

Table 450 in FIG. 4 shows an exemplar embodiment comprehensive and collective answer key and word guide. Columns 452 and 454 are minimum and additional words for the group to learn. For student learners seeking to demonstrate greater initiative or ability, the student can learn bonus words of varying lengths shown in columns 456 and 458 for three and four-letter words, respectively, using the same letter combination of ‘ab’.

The embodiment presented in FIG. 4 allows the instructor to assess and test the group's learning of spelling and vocabulary. It also allows the instructor to more readily learning deficiencies among the group of students. The instructor can vary the assignment of students into various groups to enhance the group learning experience and progress.

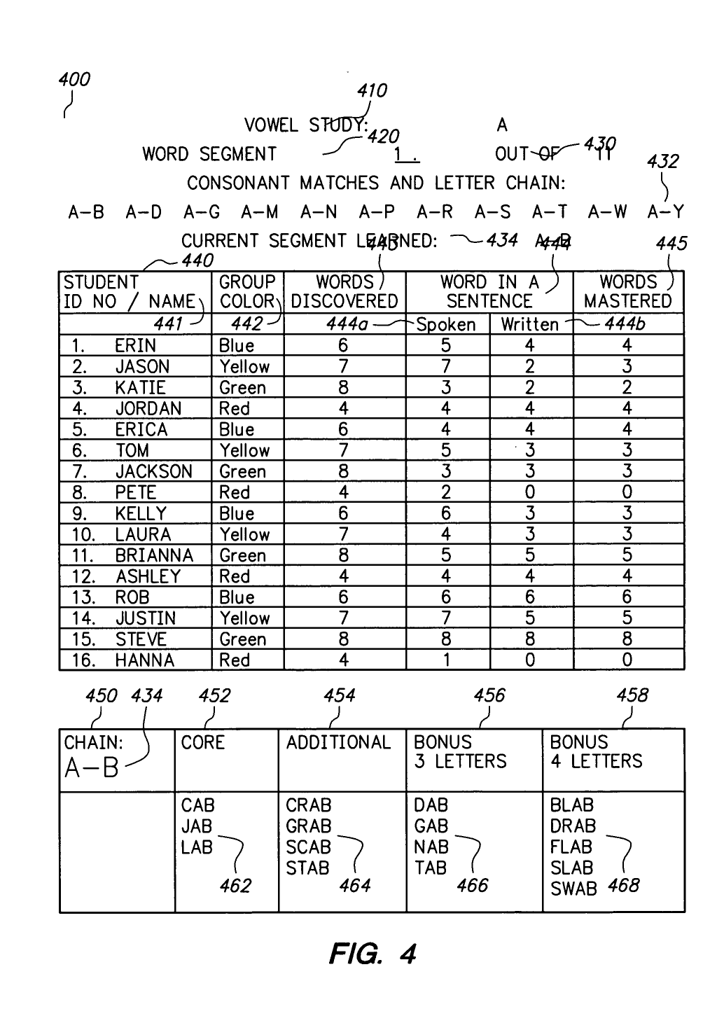

The embodiment in FIG. 5 is a reproducible document which allows the instructor to select a minimal pair for student use, learning and exercises. Rows 510 are horizontal rows with the preprinted minimal pair “at”. The learner can select any of the 26 letters of the English language shown in table 520 to insert before or after the minimal pairs in rows 510 to learn and discover new words. The learner or instructor will consult a dictionary to determine if any such new letter chains containing the minimal pair are valid words. The instructor can generate other reproducible worksheets with different minimal pairs for exercises for learners. In lines 530, the learner having read or learned a definition for a discovered valid word can write a sentence containing the valid word. The instructor or other learners may read the sentence to determine and assess whether the learner has comprehended the meaning of the valid word and used it properly in a sentence.

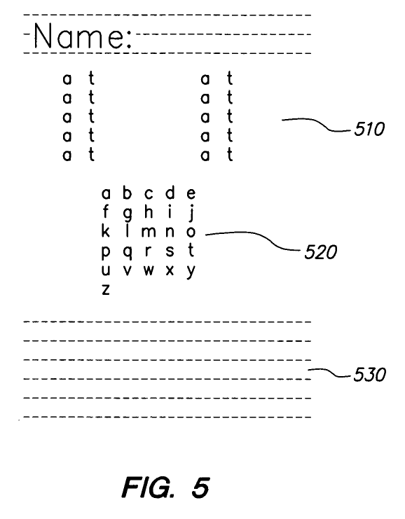

FIG. 6 embodies a computer screen that shows a learner who has created and discovered words with the minimal pair “at” in grid 610. From the alphabet grid 620, the learner has clicked and dragged the letter “p” to determine that “pat” is a valid English word. The imbedded dictionary database from the computer programmatically generates definition 630 of “pat” as the discovered word of the learner.

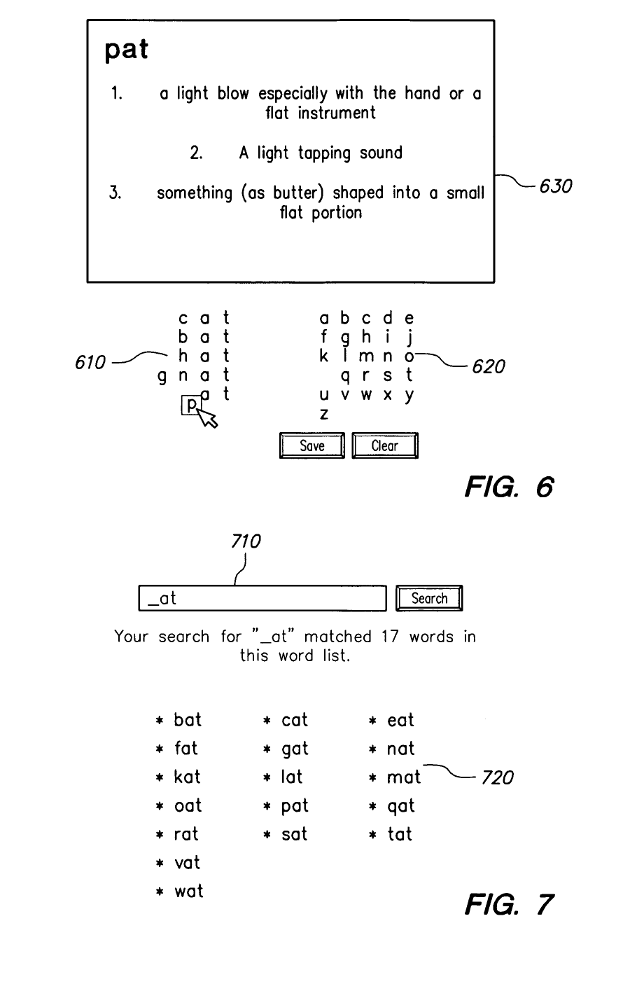

FIG. 7 is an embodiment of a computer screen showing a presentation of possible valid English words from minimal pair “at” entered in search bar 710. The learner or teacher can refer to correct matches of valid words discovered from results list 720.

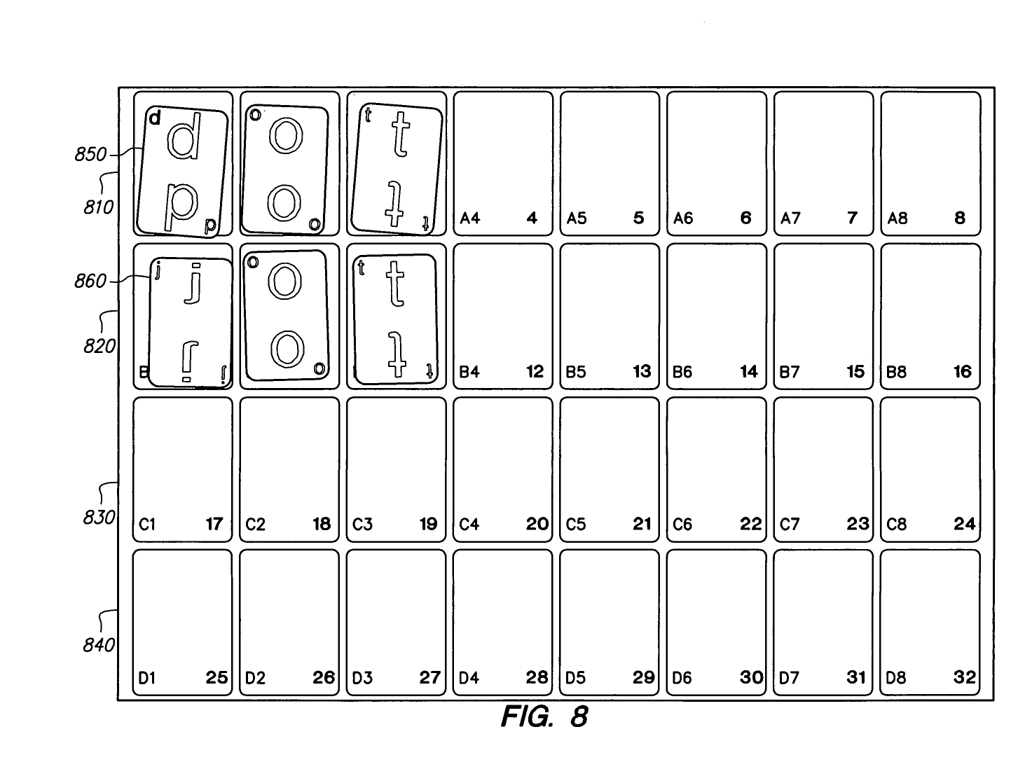

FIG. 8 is a flat playing surface with a matrix of rows for placing letter cards by the learner to discover words containing minimal pairs. This embodiment contains four rows and eight columns. Rows 810, 820, 830, and 840 show algebraic notation within each bordered space for placement of letter cards by a learner. The same bordered spaces also contain numeric notation 1 through 32. Word 850 is the word “dot” which the learner has discovered and spelled from the minimal pair of “ot”, and word 860 is the word “jot” which the learner has formed with the placement of “j” in front of “ot”.

### OBJECTS AND ADVANTAGES

Key objects and advantages to the present invention are: (a) to provide a written and tactile tool for language learners to discover spelling and vocabulary of words by systematically using the alphabet; and (b) to provide a method of word discovery, games and exercises with the use of a board with notation for the learner or player to play and correct the placement of letters to form and discovery words in a collaborative manner.

Further, the present invention provides an automated means to programmatically identify all possible valid words containing a set of two or more adjacent letters. The invention fosters an effective tool to build spelling and vocabulary skills on an interactive, mutually basis, rather than rote process of memorization. For more advanced learners, they can learn etymology behind words to increase their vocabulary and identify patterns of meanings and spellings of words.

What is claimed is:

1. A method for discovering and enhancing vocabulary and spelling skill in a person, the method comprising:
providing a visual grid, said grid having at least four uniformly shaped adjacent spaces placed in a plurality of horizontal rows;
displaying within each horizontal row of spaces a chain of least two letters of an alphabet of a language in adjacent position wherein at least one blank space remains on both the left and right sides of the adjacent letters, and each additional row having same letters and position;
requiring the person to select a letter from the plurality of letters of the alphabet to insert in a space adjacent to the existing chain of letters with an objective to form or continue to form a valid word of a designated language;
determining by consultation with a dictionary database of valid words of the designated language if the person properly formed a valid word with the addition of at least a single letter to said chain;
repeating said displaying, said requiring, said determining;
wherein said repeating permits the person to learn the validity, vocabulary and spelling of all valid words of said language that contain said two letters.

2. The method of claim 1, wherein all valid words of said language containing said adjacent letters are alphabetized and compiled in an answer key for access and display to the person learning words of said language.

3. The method of claim 1, wherein said displaying of letters and words and said dictionary database is electronic and said determining by consultation is computer-controlled.

4. The method of claim 1, wherein the completion of a threshold number or percentage of valid words by a person allows the person to methodically and systematically learn a new set of valid words containing a different set a plurality of letters that are displayed in a predetermined order.

5. The method of claim 1, wherein the letters are preprinted on a physical card or tile and said displaying is on a flat surface made of one of a plurality of materials consisting of paper, cardboard, plastic, and metal with preprinted, bordered spaces of at least the size of said card or tile arranged rows for manual placement of letter cards or tiles within said spaces by the person.

6. The method of claim 5, wherein each of said preprinted, bordered spaces are marked and uniquely and individually designated with a numeric, alphanumeric or algebraic notation placed within or outside the perimeter of each of said preprinted spaces.

7. The method of claim 6 further comprising:
utilizing said notation among at least two persons to place letters in positions to attempt the formation of valid words;
referring to source of valid words in a dictionary database;
correcting the placement of letters to form valid words;
recording all words that are formed that contain said chain of at least two letters.

8. The method of claim 6 further comprising:
utilizing said notation among at least two persons to place letters in positions to attempt the formation of valid words that contain said chain of at least two letters;
monitoring and tallying all valid words discovered and formed that contain said chain of at least two letters
wherein said persons are engaged in a plurality of word games and exercises under predetermined rules to aid said persons in learning and mastering the spelling and vocabulary of all said words discovered and formed.
